(19) United States
(12) Patent Application Publication
(10) Pub. No.: US 2008/0271509 A1
(43) Pub. Date: Nov. 6, 2008

(54) Computer controlled flexible rolling machine

(75) Inventors: Ronald Young, Orange, CA (US); Steven M. Riley, Yorba Linda, CA (US)

Correspondence Address: STETINA BRUNDA GARRED & BRUCKER, 75 ENTERPRISE, SUITE 250, ALISO VIEJO, CA, 92656, US

(73) Assignee: R&Y Enterprises, LLC

(21) Appl. No.: 11/799,351

(22) Filed: May 1, 2007

(51) Int. Cl. B21D 9/10; B21D 5/00; G01B 7/00; G05B 15/00; B21D 5/14

(52) U.S. Cl. 72/110; 700/1; 702/40

(57) ABSTRACT

There is provided a flexible rolling machine operative to form a metal panel. The machine includes a frame and a series of rollers. The machine includes at least one primary bottom roller, at least one secondary bottom roller, and at least one top roller. Each roller includes a cylinder. The cylinder comprises a proximal portion that is coupled to the frame and a distal portion that is coupled to at least one rolling member. The individual cylinders have independently adjustable lengths. The machine further includes a non-contact measuring system operative to measure the panel.

### CROSS-REFERENCE TO RELATED APPLICATIONS

Not Applicable.

### STATEMENT RE: FEDERALLY SPONSORED RESEARCH/DEVELOPMENT

Not Applicable

### BACKGROUND

This invention relates in general to a rolling machine. Specifically, the invention relates to a flexible rolling machine operative to form metal panels.

Large, cylindrical metal bodies or tanks are used in a number of different industrial applications. These metal tanks are constructed from individual panels that start as flat sheets of metal. Ultimately, a curvature must be applied to each panel. However, before a curvature is formed into a panel, the panel is machined on one side to create a series of ribs. Machining the panel reduces the overall weight of the panel as well as enhances the strength of the resultant cylinder. After the panel is machined, a curve is formed in the panel.

When forming such curved panels, they cannot be rolled in a conventional pinch roll. Rolling a panel that has been machined on the inside creates a panel with an anticliastic curve in it. An example of a panel having an anticliastic curve in it can be seen in FIG. 1. In order to avoid such curvature, the panels must be formed in a press brake using the “bump form” method.

Bump forming entails incrementally moving the panel small distances, and bumping the panel after each movement. Bump forming steps the panel ahead slightly for the next bump until the entire panel has been formed. Some panels may require more than 400 bumps in order to properly form the entire panel. In addition, operators will add shims to certain areas while bump forming to defeat the anticliastic tendencies of the panel.

After the panel has been bump formed, it is taken to a check fixture where it is inspected and marked. The panel is then returned to the press brake for touch-up work until it is deemed acceptable. Once the panels have been sufficiently formed, they are welded together to form a cylinder.

Some of the existing panels are up to fourteen feet wide and up to forty feet long. As such, it may take 2-4 men to handle the panels throughout this process. This can be very tedious and exhausting, especially if the panel must be formed within a small tolerance, which would likely require a large amount of touch-up work.

Therefore, there is a need in the art for a flexible rolling machine that is capable of forming a metal panel without having to place the panel on a check fixture.

### BRIEF SUMMARY

According to an aspect of the present invention, there is provided a flexible rolling machine operative to form a metal panel. The machine includes a frame and a series of rollers. The machine includes at least one primary bottom roller, at least one secondary bottom roller, and at least one top roller. Each roller includes a cylinder. The cylinder comprises a proximal portion that is coupled to the frame and a distal portion that is coupled to at least one rolling member. The individual cylinders have independently adjustable lengths. The machine further includes a non-contact measuring system operative to measure the panel.

The present invention is capable of forming a curve within a panel in accordance with desired dimensions. In this regard, the panels may be formed without requiring handlers to move the panels from the device and onto a check fixture. Rather, the rollers may be independently adjustable to form each panel. As the panel exits the machine, the non-contact measuring system measures the panel to determine whether the panel has been formed to the prescribed curvature.

The flexible rolling machine may include at least one drive wheel coupled to the frame, however, in the preferred embodiment, the rolling machine includes four drive wheels. The drive wheel is operative to drive the panel through the machine. The rolling machine may also include a data input to enable a user to input data/commands to regulate operation of the machine. The rolling machine may further include a central processing unit (CPU). The CPU may be in communication with the primary bottom roller, the secondary bottom roller, the top roller, the non-contact measuring system and/or the data input.

It is contemplated that the machine includes a series of rollers that are operable to form a panel. In particular, the machine may include a plurality of primary bottom rollers. The primary bottom rollers may be arranged in first and second rows such that the cylinders of the second row of primary bottom rollers are offset from the cylinders of the first row of primary bottom rollers. The machine may also include a plurality of secondary bottom rollers which may also be arranged in offsetting first and second rows. The machine may further include a plurality of top rollers. The top rollers may be arranged in offsetting first and second rows.

In another embodiment of the invention, the panel traverses through the machine along a first direction, preferably horizontal, wherein a second direction is generally perpendicular to the first direction. Preferably, the first direction is horizontal and the second direction is vertical. The panel is formed by a series of rollers. At least one primary bottom roller contacts the panel at a primary contact point. At least one secondary bottom roller contacts the panel at a secondary contact point, and at least one top roller contacts the panel at a top contact point. The distance along the second direction between the primary and top contact points may be adjustable. Likewise, the distance along the second direction between the top and secondary contact points may also be adjustable.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a panel having an anticliastic curve;

FIG. 2A is a side view of a flexible rolling machine including a series of rollers and a non-contact measuring system;

FIG. 2B is a perspective view of a panel formed in accordance with the present invention;

FIG. 3 is a side view of the flexible rolling machine comprising primary bottom rollers, secondary bottom rollers, and top rollers;

FIG. 3A is a front view of the flexible rolling machine of FIG. 3;

FIG. 4 is a cutaway top view of the primary bottom rollers, secondary bottom rollers and the top rollers;

FIG. 5 is a cutaway side view showing a drive wheel driving a panel, wherein the panel includes corrugations which mate with the drive wheel;

FIG. 6 is a schematic diagram of an embodiment of the invention including a central processing unit (CPU), a data input, at least one drive wheel, rollers, a panel positioning sensor, and a non-contact measuring system.

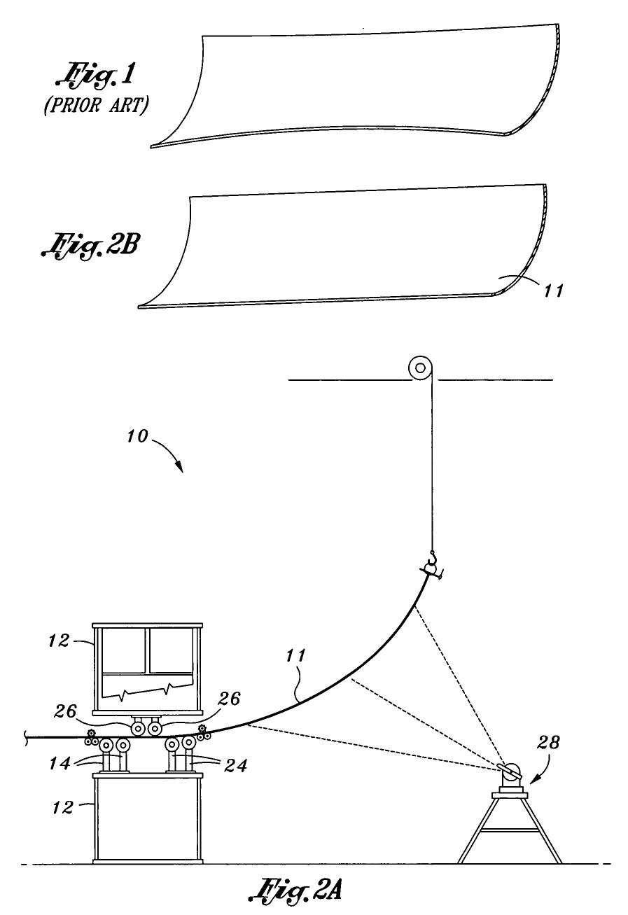

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

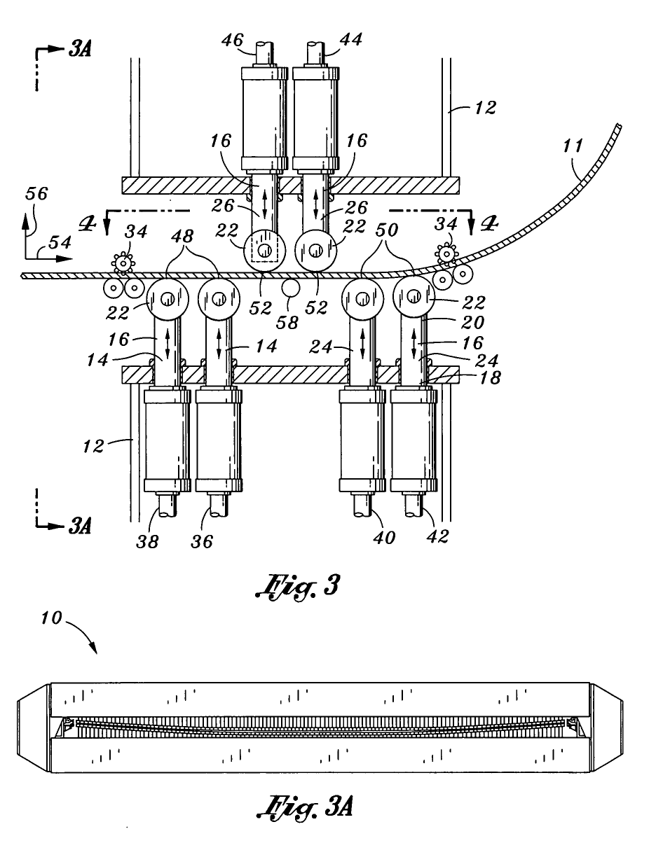

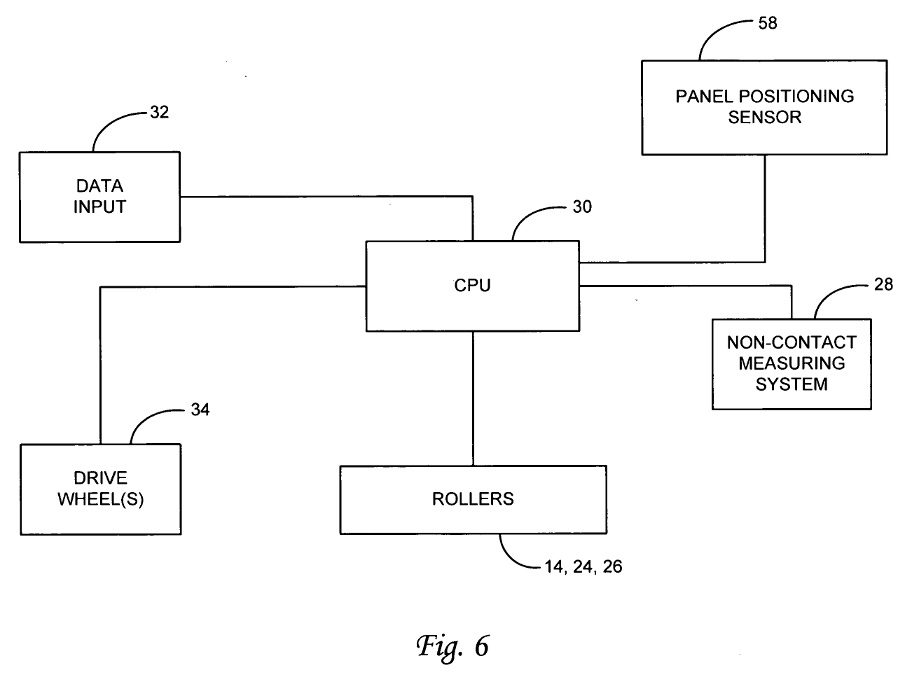

Referring now to FIGS. 2-6, there is provided a flexible rolling machine 10 capable of forming a curved panel 11 from a substantially planar panel. According to an aspect of the present invention, the machine 10 includes a frame 12 and a series of roller assemblies 14, 24, 26 that form the panel 11 into a desired curvature. Preferably, the machine 10 includes at least one primary bottom roller 14, at least one secondary bottom roller 24, and at least one top roller 26. Each roller assemblies 14, 24, 26 includes a cylinder 16 that is coupled to the frame 12. The cylinder 16 includes a proximal portion 18 that is coupled to the frame 12 and a distal portion 20 that is coupled to at least one rolling member 22. In the preferred embodiment of the invention, a pair of rolling members 22 is coupled to each cylinder 16. The individual cylinders 16 have independently adjustable lengths.

The flexible rolling machine 10 further includes a non-contact measuring system 28 operative to measure the panel 11 to determine whether the panel 11 conforms to the desired dimensions. Preferably the non-contact measurement system 28 employs laser radar technology to measure the panel 11. However, other non-contact measurement technology known by those skilled in the art may also be used.

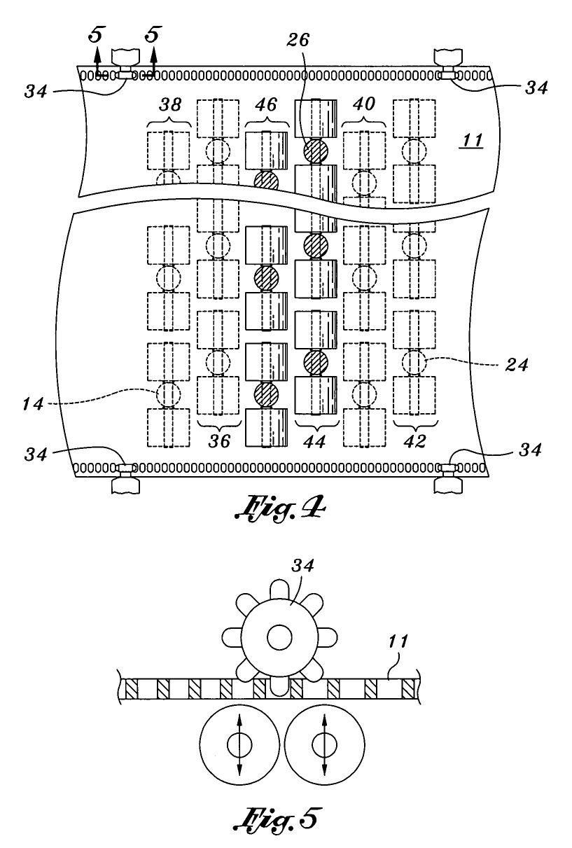

As shown in the embodiment depicted in FIG. 3, the flexible rolling machine 10 includes a panel positioning sensor 58. As a panel 11 travels through the flexible rolling machine 10, the panel positioning sensor 58 measures the distance the panel 11 has traveled. In the event the flexible rolling machine 10 does not create a curve in the panel 11 within a specified tolerance, the panel 11 may be sent back through the machine 10. The information obtained from the panel positioning sensor 58 may be particularly useful when the panel 11 is repeatedly sent through the machine 10 in order to meet the specified tolerance.

In one embodiment of the invention, the flexible rolling machine 10 includes a central processing unit (CPU) 30. The CPU 30 may be in communication with various components of the flexible rolling machine 10. According to one embodiment, the CPU 30 is in communication to the primary bottom roller(s) 14, the secondary bottom roller(s) 24, and the top roller(s) 26. In still another embodiment, the CPU 30 is in communication with the non-contact measurement system 28. The CPU 30 may further be in communication with the panel positioning sensor 58.

It is contemplated that an embodiment of the flexible rolling machine 10 includes at least one drive wheel 34 coupled to the frame 12. The drive wheel 34 is operative to drive the panel 11 through the machine 10. Preferably, the flexible rolling machine 10 includes multiple drive wheels 34, as shown in FIGS. 3 and 4. In one particular implementation, the panel 11 includes slots along the panel edges. The slots may engage with the drive wheel 34 so as to enable the drive wheel 34 to drive the panel 11. Preferably, the drive wheel 34 is a gear cogged drive wheel that mates with the slots as the drive wheel 34 rotates. FIG. 4 is a top view of the flexible rolling machine 10, with a panel 11 disposed thereon. In the embodiment shown in FIG. 4, the drive wheel 34 is a cogged drive wheel. FIG. 5 is a cutaway side view illustrating the cogged drive wheel 34 meshing with the slots on the panel 11. In one embodiment, the drive wheel 34 is in communication with the CPU 30.

According to another embodiment, the flexible rolling machine 10 includes a data input 32. The data input 32 enables the user to input data/commands to regulate operation of the machine 10. In this regard, the user may enter desired panel specifications via the data input 32. In one particular embodiment, the data input 32 is in communication with the CPU 30.

In one embodiment of the invention, the flexible rolling machine 10 includes a plurality of primary bottom rollers 14. The primary bottom rollers 14 are arranged in a first row of primary bottom rollers 36 and a second row of primary bottom rollers 38. In another embodiment, the flexible rolling machine 10 includes a plurality of secondary bottom rollers 24. The secondary bottom rollers 24 are arranged in a first row of secondary bottom rollers 40 and a second row of secondary bottom rollers 42. In still another embodiment, the flexible rolling machine 10 includes a plurality of top rollers 26 arranged in a first row of top rollers 44 and a second row of top rollers 46. In the embodiment shown in FIGS. 2-4, the flexible rolling machine 10 includes first and second rows of primary bottom rollers 26, 38, first and second rows of secondary bottom rollers 40, 42 and first and second rows of top rollers 44, 46.

According to one embodiment, the cylinders 16 of the first and second rows of primary bottom rollers 36, 38 are evenly spaced apart. Similarly, in another embodiment, the cylinders 16 of the first and second rows of secondary bottom rollers 40, 42 are evenly spaced apart. In still another embodiment, the cylinders 16 of the first and second rows of top rollers 44, 46 are evenly spaced apart.

The arrangement of the cylinders 16 is also staggered, as is shown in FIG. 4. Accordingly, in one particular embodiment, the cylinders 16 of the second row of primary bottom rollers 38 are offset from the cylinders 16 of the first row of primary bottom rollers 36. In another embodiment, the cylinders 16 of the second row of secondary bottom rollers 42 are offset from the cylinders 16 of the first row of secondary bottom rollers 40. Likewise, in a further embodiment, the cylinders 16 of the second row of top rollers 46 are offset from the cylinders 16 of the first row of top rollers 44. Although the cylinders 16 are preferably staggered, it is understood that other embodiments of the invention may include cylinders 16 that are aligned.

According to another embodiment of the present invention, the panel 11 traverses through the machine 10 along a first direction 54. Preferably the first direction 54 is horizontal. A second direction 56 is generally perpendicular to the first direction 54. The machine 10 includes a frame 12, and at least one primary bottom roller 14, at least one secondary bottom roller 24, and at least one top roller 26. The primary bottom roller(s) 14 includes a cylinder 16 having a proximal portion 18 coupled to the frame 12, and a distal portion 20 coupled to at least one rolling member 22. The roller member 22 of the primary bottom roller 14 contacts the panel 11 at a primary contact point 48. The secondary bottom roller(s) 24 includes a cylinder 16 having a proximal portion 18 coupled to the frame 12, and a distal portion 20 coupled to at least one rolling member 22. The roller member 22 of the secondary bottom roller 24 contacts the panel 11 at a secondary contact point 50. The top roller(s) 26 includes a cylinder 16 having a proximal portion 18 coupled to the frame 12, and a distal portion 20 coupled to at least one rolling member 22. The roller member 22 of the top roller 26 contacts the panel 11 at a top contact point 52. In one embodiment, the distances between the primary contact point 48, top contact point 52, and secondary contact point 50, along the second direction is adjustable. In this regard, the contact points 48, 50, 52 may be adjusted by adjusting the length of the corresponding cylinders 16.

The operation of an embodiment of the invention is described as follows. A user inputs the desired dimensions for a specific panel 11 into the data input 32. The panel 11 is loaded into the flexible rolling machine 10. The data input 32 controls the drive wheels 34 as they drive the panel 11 through the machine 10. As the panel 11 traverses through the machine 10, the series of rollers 14, 24, 26 form a curve in the panel 11. The rollers 14, 24, 26 are attached to cylinders 16, wherein each cylinder 16 has an adjustable length. The length of each cylinder 16 is adjusted to form the desired curvature within a specific panel 11. The length of each cylinder 16 is controlled by the CPU 30.

After the panel 11 is driven through the series of rollers 14, 24, 26, it is measured by the non-contact measuring system 28. The measuring system 28 determines whether the panel 11 was formed in accordance with the prescribed curvature. If the panel 11 does not conform to the prescribed curvature the panel 11 is sent back through the machine 10. After traversing through the machine 10 a second time, the panel 11 is again measured by the measuring system 28. The panel 11 is repeatedly sent through the machine 10 until the panel 11 conforms with the desired dimensions.

Although the embodiment described above is fully automated and forms a panel 11 independent of user participation, other than the initial desired dimension input, other embodiments are less automated and require more user participation. For instance, the length of the individual cylinders 16 and the drive wheel(s) 34 may be directly controlled by the user.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A flexible rolling machine operative to form a metal panel, the machine comprising:
a frame;
at least one primary bottom roller including a cylinder having a proximal portion coupled to the frame and a distal portion coupled to at least one rolling member, wherein the cylinder has an independently adjustable length;
at least one secondary bottom roller including a cylinder having a proximal portion coupled to the frame and a distal portion coupled to at least one rolling member, wherein the cylinder has an independently adjustable length;
at least one top roller including a cylinder having a proximal portion coupled to the frame and a distal portion coupled to at least one rolling member, wherein the cylinder has an independently adjustable length, wherein the top roller is disposed between the primary and secondary rollers; and
a non-contact measuring system being operative to measure the panel.

2. The flexible rolling machine of claim 1, further comprising a central processing unit operative to control operation of the flexible rolling machine, the central processing unit being in communication with the at least one primary bottom roller, the at least one secondary bottom roller, the at least one top roller and the non-contact measuring system.

3. The flexible rolling machine of claim 2, further comprising a data input to enable a user to input data/commands to regulate operation of the machine, wherein the data input is in communication with the central processing unit.

4. The flexible rolling member of claim 1, further comprising at least one drive wheel operative to drive the panel through the machine, the drive wheel being coupled to the frame.

5. The flexible rolling machine of claim 4, further comprising a central processing unit in communication with the at least one drive wheel.

6. The flexible rolling machine of claim 1, comprising a plurality of primary bottom rollers, the plurality of primary bottom rollers being arranged in a first row of primary bottom rollers and a second row of primary bottom rollers.

7. The flexible rolling machine of claim 6, wherein the cylinders of the second row of primary bottom rollers are offset from the cylinders of the first row of primary bottom rollers.

8. The flexible rolling machine of claim 1, comprising a plurality of secondary bottom rollers, the plurality of secondary bottom rollers being arranged in a first row of secondary bottom rollers and a second row of secondary bottom rollers.

9. The flexible rolling machine of claim 8, wherein the cylinders of the second row of secondary bottom rollers are offset from the cylinders of the first row of secondary bottom rollers.

10. The flexible rolling machine of claim 1, comprising a plurality of top rollers, the plurality of top rollers being arranged in a first row of top rollers and a second row of top rollers.

11. The flexible rolling machine of claim 10, wherein the cylinders of the second row of top rollers are offset from the cylinders of the first row of top rollers.

12. The flexible rolling machine of claim 1, wherein the non-contact measuring system is a laser radar measurement system.

13. The flexible rolling machine of claim 1, wherein the cylinder of the at least one primary bottom roller is coupled to two rolling members.

14. The flexible rolling machine of claim 1, wherein the cylinder of the at least one secondary bottom roller is coupled to two rolling members.

15. The flexible rolling machine of claim 1, wherein the cylinder of the at least one top roller is coupled to two rolling members.

16. A flexible rolling machine being operative to form a metal panel, wherein the panel traverses through the machine in a first direction, wherein a second direction is generally perpendicular to the first direction, the machine comprising:
a frame;
at least one primary bottom roller including a cylinder coupled to the frame, the cylinder having a distal portion coupled to at least one primary rolling member, wherein the at least one primary rolling member contacts the panel at a primary contact point;
at least one secondary bottom roller including a cylinder coupled to the frame, the cylinder having a distal portion coupled to at least one secondary rolling member, wherein the at least one secondary rolling member contacts the panel at a secondary contact point;
at least one top roller including a cylinder coupled to the frame, the cylinder having a distal portion coupled to at least one top rolling member, wherein the at least one top rolling member contacts the panel at a top contact point, wherein the distance between the primary contact point and the top contact point along the second direction is adjustable; and
a non-contact measuring system being operative to measure the panel.

17. The flexible rolling machine of claim 16, further comprising at least one drive wheel operative to drive the panel through the machine, the drive wheel being coupled to the frame.

18. The flexible rolling machine of claim 16, further comprising a central processing unit operative to control operation of the flexible rolling machine, the central processing unit being in communication with the at least one primary bottom roller, the at least one secondary bottom roller, the at least one top roller and the non-contact measuring system.

19. A flexible rolling machine being operative to form a metal panel, wherein the panel traverses through the machine along a first direction, wherein a second direction is generally perpendicular to the first direction, the machine comprising:
a frame;
at least one primary bottom roller including a cylinder coupled to the frame, the cylinder having one end portion coupled to at least one primary rolling member, wherein the at least one primary rolling member contacts the panel at a primary contact point;
at least one secondary bottom roller including a cylinder coupled to the frame, the cylinder having one end portion coupled to at least one secondary rolling member, wherein the at least one secondary rolling member contacts the panel at a secondary contact point;
at least one top roller including a cylinder coupled to the frame, the cylinder having one end portion coupled to at least one top rolling member, wherein the at least one top rolling member contacts the panel at a top contact point, wherein the distance between the top contact point and the secondary contact point along the second direction is adjustable; and
a non-contact measuring system being operative to measure the panel.

20. The flexible rolling machine of claim 19, further comprising at least one drive wheel operative to drive the panel through the machine, the drive wheel being coupled to the frame.
